(19) United States
(12) Patent Application Publication
(10) Pub. No.: US 2012/0038247 A1
(43) Pub. Date: Feb. 16, 2012

(54) ULTRASONIC MOTOR

(75) Inventor: Tetsuyuki SAKAMOTO, Hachioji-shi (JP)

(73) Assignee: OLYMPUS CORPORATION, Tokyo (JP)

(21) Appl. No.: 13/181,671

(22) Filed: Jul. 13, 2011

(30) Foreign Application Priority Data
Aug. 10, 2010 (JP) 2010-179612

(51) Int. Cl. H02N 2/12

(52) U.S. Cl. 310/323.16

(57) ABSTRACT

An ultrasonic motor includes a transducer configured to be assembled as one unit by a piezoelectric device, a holding member, and a friction contact member, a hollow rotor configured to contact the friction contact member, a first driving force transmitting member, a press member and a support mechanism. The support mechanism includes a second driving force transmitting member, a transmission shaft bearing having an inner ring in which the second driving force transmitting member is fitted, and a bearing support member configured to be disposed in the upper surface of the case member, the bearing support member supporting the transmission shaft bearing so that the second driving force transmitting member is drivable together with the first driving force transmitting member and so that the transmission shaft bearing is drivable.

### CROSS-REFERENCE TO RELATED APPLICATIONS

This application is based upon and claims the benefit of priority from prior Japanese Patent Application No. 2010-179612, filed Aug. 10, 2010, the entire contents of which are incorporated herein by reference.

### BACKGROUND OF THE INVENTION

1. Field of the Invention

The present invention relates to a rotary ultrasonic motor used as, for example, an image vibration correcting unit of a digital camera or an actuator of an autofocus (AF) lens or the like.

2. Description of the Related Art

Recently, ultrasonic motors have been attracting attention as new motors that replace electromagnetic motors. The ultrasonic motors use the vibration of a transducer such as a piezoelectric device. As compared with the conventional electromagnetic motors, the ultrasonic motors have the following advantages: low-rotation high torque obtained without any gears, high coercive force, high resolution, a high degree of silence, no generation of magnetic noise, no influence of magnetic noise, etc.

Such an ultrasonic motor has been disclosed in, for example, Jpn. Pat. Appin. KOKAI Publication No. 9-117168. In this ultrasonic motor, a transducer comprises plate-like piezoelectric devices stacked on each other, elastic bodies that vertically catch the piezoelectric devices from both sides, and an abrasion-resistant material which is a driven body affixed to the surface of the elastic bodies provided on the upper side of the piezoelectric devices. The abrasion-resistant material is pressed by a rotor.

In this ultrasonic motor, the plate-like piezoelectric devices are stacked on each other, such that the transducer simultaneously induces a longitudinal vibration and a torsional vibration, and from these two vibrations, generates an elliptical vibration. A driving force generated at this moment from the elliptical vibration generating surfaces of the piezoelectric devices is transmitted to the abrasion-resistant material, and rotates the rotor via the abrasion-resistant material.

In an ultrasonic motor different from the above-mentioned ultrasonic motor, a transducer comprises a piezoelectric device, a holding member which holds the piezoelectric device, and friction contact members arranged in the piezoelectric device. A rotor is in direct contact with the friction contact members. Thus, if a voltage is applied to the piezoelectric device, a longitudinal vibration and a torsional vibration are induced, and an elliptical vibration is generated. This elliptical vibration is directly transmitted to, via the friction contact members, a rotor which is a driven body, and the rotor is driven by friction.

In such an ultrasonic motor, versatility of the ultrasonic motor and stabilization of the characteristics of the ultrasonic motor are attained by packaging primary components as a unit.

The configuration of the above-described ultrasonic motor disclosed in Jpn. Pat. Appin. KOKAI Publication No. 9-117168 may be complicated because the plate-like piezoelectric devices are stacked and the elastic bodies catch the piezoelectric devices.

Furthermore, a shaft which passes through the transducer and extends from the upper elastic body is only utilized as part of a pressing mechanism for pressing the rotor. Therefore, it is difficult for this shaft to transmit a rotation force to the rotor in an axial direction. That is, it might be difficult to apply this ultrasonic motor to an instrument or the like having no space in a diameter direction of the rotor.

Moreover, as described above, when the friction contact members are in direct contact with the rotor and the rotor is driven by the friction contact members, the accuracy of the relative positions of the central (rotation) shaft of the rotor and the friction contact members may be decreased by the processing and assembly of the ultrasonic motor.

When the piezoelectric devices are pressed by a pressing member and the friction contact members are thus pressed toward the rotor, the point of application for pressing (a contact point between the pressing member and the piezoelectric device) is displaced by the assembly of the transducer.

As a result, the posture of the transducer is tilted, and the contact surfaces of the rotor and the transducer may be out of equal contact. This may lead to the deterioration of the driving characteristics of the ultrasonic motor.

### BRIEF SUMMARY OF THE INVENTION

The present invention has been made under these circumstances, and is directed to provide an ultrasonic motor having packaged primary components, having a simple configuration, and having stable driving characteristics.

According to an aspect of embodiments, an ultrasonic motor includes a piezoelectric device, the section of the piezoelectric device perpendicular to its central axis having a length ratio of a rectangle, the piezoelectric device inducing a longitudinal vibration and a torsional vibration in response to a voltage, and generating an elliptical vibration from the longitudinal vibration and the torsional vibration, a holding member configured to hold the piezoelectric device at the position of a node of the torsional vibration, a friction contact member configured to be provided in an elliptical vibration generating surface of the piezoelectric device, a transducer configured to be assembled as one unit by the piezoelectric device, the holding member, and the friction contact member, a hollow rotor configured to contact the friction contact member, the rotor rotating around a shaft in a direction perpendicular to a plane direction of the elliptical vibration generating surface when a driving force is transmitted to the rotor from the friction contact member, a first driving force transmitting member configured to be adhesively fixed to the rotor and which rotates together with the rotor, a case member configured to have a positioning groove to position the transducer and configured to house the transducer, a press member configured to press the transducer housed in the case member toward the rotor; and a support mechanism configured to be disposed in the case member and configured to drivably support the first driving force transmitting member so that the rotor is drivable, wherein the support mechanism includes a second driving force transmitting member configured to contact a proximal end of the first driving force transmitting member at a distal end of the second driving force transmitting member and configured to be driven together with the first driving force transmitting member, a transmission shaft bearing having an inner ring in which the second driving force transmitting member is fitted, and a bearing support member configured to be disposed in the upper surface of the case member, the bearing support member supporting the transmission shaft bearing so that the second driving force transmitting member is drivable together with the first driving force transmitting member and so that the transmission shaft bearing is drivable.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of an ultrasonic motor according to a first embodiment of the present invention;

FIG. 2 is an exploded perspective view of the ultrasonic motor;

FIG. 3 is a front view of the ultrasonic motor;

FIG. 4 is a side view of the ultrasonic motor;

FIG. 5 is a sectional view along the line 5-5 shown in FIG. 3;

FIG. 6 is a sectional view along the line 6-6 shown in FIG. 4;

FIG. 7 is a perspective view of an ultrasonic motor according to a second embodiment of the present invention;

FIG. 8 is an exploded perspective view of the ultrasonic motor;

FIG. 9 is a front view of the ultrasonic motor;

FIG. 10 is a side view of the ultrasonic motor;

FIG. 11 is a sectional view along the line 11-11 shown in FIG. 9; and

FIG. 12 is a sectional view along the line 12-12 shown in FIG. 10.

### DETAILED DESCRIPTION OF THE INVENTION

Hereinafter, embodiments of the present invention will be described in detail with reference to the drawings.

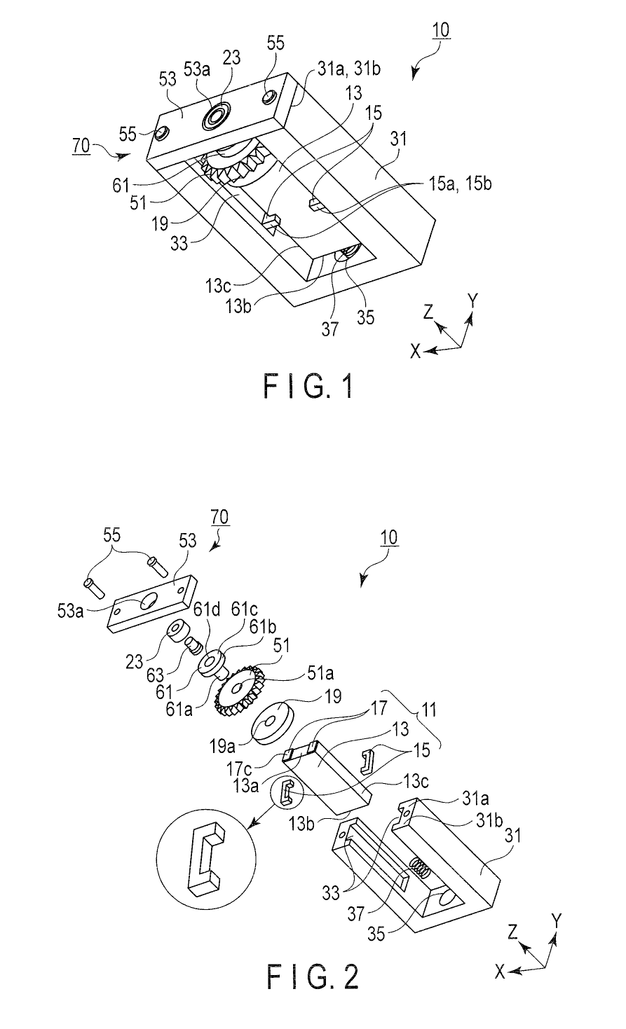

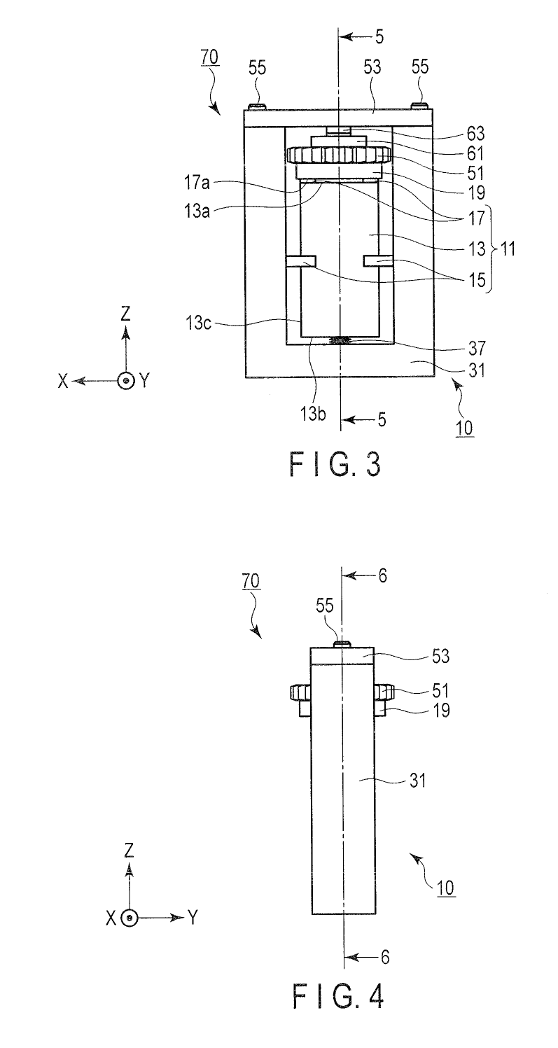

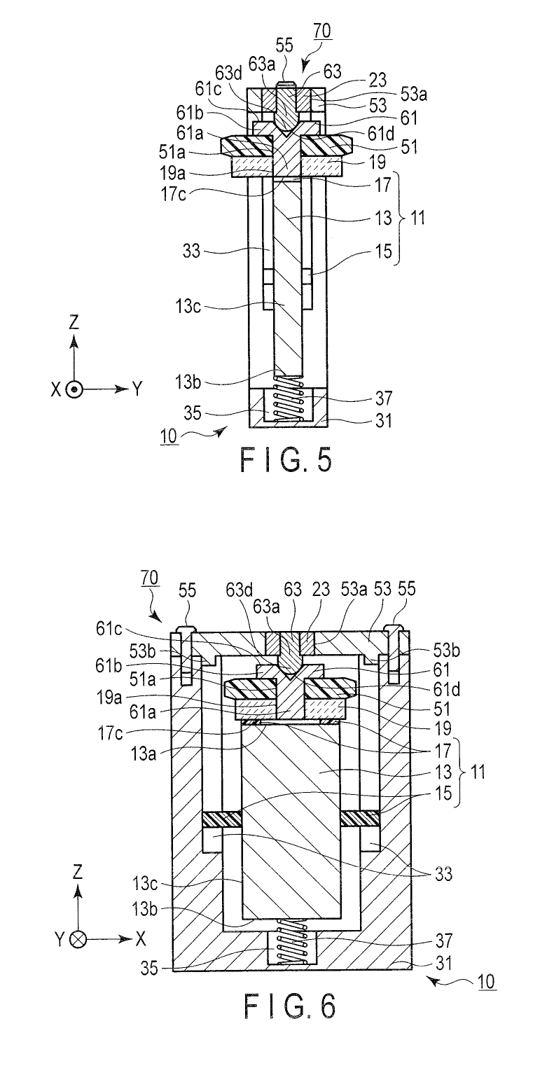

The first embodiment is described with reference to FIG. 1, FIG. 2, FIG. 3, FIG. 4, FIG. 5, and FIG. 6.

From now on, the width directions of a transducer 11 and a piezoelectric device 13 are an X-axis direction, the thickness directions of the transducer 11 and the piezoelectric device 13 perpendicular to the X-axis direction are a Y-axis direction, and the height directions of the transducer 11 and the piezoelectric device 13 perpendicular to the X-axis direction and the Y-axis direction are a Z-axis direction.

An ultrasonic motor 10 has the transducer 11 which is a primary component of the ultrasonic motor 10.

As shown in FIG. 2, the transducer 11 has the piezoelectric device 13, piezoelectric device holding members (hereinafter, holding members 15), and friction contact members 17. In response to a voltage, the piezoelectric device 13 induces longitudinal vibration that expands and contracts in the direction of the rotation axis of the transducer 11, and a torsional vibration that is generated on the rotation axis of the transducer 11 as a torsion axis. From these two vibrations, the piezoelectric device 13 generates an elliptical vibration. The holding members 15 hold the piezoelectric device 13 at the position of a node of the torsional vibration of the piezoelectric device 13. The friction contact members 17 are arranged in one surface of an elliptical vibration generating surface of the piezoelectric device 13.

As shown in FIG. 2, FIG. 5, and FIG. 6, the section of the piezoelectric device 13 perpendicular to its central axis has a length ratio of a rectangle. An upper surface 13a of the piezoelectric device 13 serves as the elliptical vibration generating surface of the piezoelectric device 13 for generating an elliptical vibration from the longitudinal vibration and the torsional vibration.

As shown in FIG. 2, the holding members 15 are Π shaped (depressed). Each of the holding members 15 is fitted at the position of the node of the torsional vibration of the piezoelectric device 13, and is fixedly attached to the position of the node by, for example, an adhesive agent.

Two friction contact members 17 are arranged in the elliptical vibration generating surface, and are fixedly attached thereto by, for example, an adhesive agent.

As shown in FIG. 2, the holding member 15 and the friction contact members 17 are fixedly attached to the piezoelectric device 13 as described above, so that the transducer 11 is assembled as one unit by the piezoelectric device 13, the holding members 15, and the friction contact members 17. The transducer 11 assembled as one unit is packaged (enveloped) by the later-described case member 31.

The friction contact members 17 are in contact with a rotor 19 which is a driven body in contact surfaces 17c, and transmit, to the rotor 19, a driving force to rotate the rotor 19. That is, the rotor 19 as a driven body, which is driven (rotated) by the elliptical vibration that is its driving (rotation) force transmitted from the friction contact members 17, is in contact with the friction contact members 17.

As described above, the rotor 19 contacts the friction contact members 17, and when the driving force is transmitted to the rotor 19 from the friction contact members 17, the rotor 19 rotates around a (rotation) shaft in a direction (Z-axis direction) perpendicular to a plane direction of the elliptical vibration generating surface. The rotor 19 has a hollow circular shape having an opening 19a.

As shown in FIG. 5 and FIG. 6, a proximal end 61b of a first transmission shaft 61, which is a central (rotation) shaft of the rotor 19, is adhesively fixed to the opening 19a of the rotor 19. Therefore, when the rotor 19 rotates, the first transmission shaft 61 also rotates together with the rotor 19. The first transmission shaft 61 is T-shaped.

As shown in FIG. 5 and FIG. 6, the first transmission shaft 61 is fitted in an opening 51a of a rotation force transmission gear 51 between a distal end 61a and a proximal end 61b. The first transmission shaft 61 rotates together with the rotor 19, and thereby transmits a driving force (turning force) to the rotation force transmission gear 51 and rotates the rotation force transmission gear 51. Thus, the first transmission shaft 61 is a first driving force transmitting member for transmitting the driving force to the rotation force transmission gear 51.

The rotation force transmission gear 51 is mounted on the rotor 19, and is toothed with an unshown external device on the side surface of the case member 31. As shown in FIG. 2, the rotation force transmission gear 51 has the opening 51a which the first transmission shaft 61 is fitted in and passed through, as described above. This rotation force transmission gear 51 rotates when a driving force (turning force) is transmitted thereto from the first transmission shaft 61 via the friction contact members 17 and the rotor 19. The rotation force transmission gear 51 transmits this driving force to the unshown external device, and drives the device. The rotation force transmission gear 51 is disposed in the rotor 19 coaxially with the rotor 19 by passing the first transmission shaft 61 through the opening 51a.

The first transmission shaft 61 that passes through the opening 51a is also adhesively fixed to the rotation force transmission gear 51 in its surface contacting the rotation force transmission gear 51. The first transmission shaft 61 in the present embodiment is a device side driving force transmitting member for transmitting a driving force to the unshown external device via the rotation force transmission gear 51.

As shown in FIG. 2, FIG. 5, and FIG. 6, the first transmission shaft 61 has a conical recess 61d in an upper surface 61c of the proximal end 61b. A second transmission shaft 63 which is a second driving force transmitting member is provided above the recess 61d. The second transmission shaft 63 has, at its distal end 63a, a semispherical protrusion 63d that contacts the recess 61d. The size of the semispherical shape of the protrusion 63d is smaller than the size of the conical shape of the recess 61d.

The second transmission shaft 63 rotates together with the first transmission shaft 61. The second transmission shaft 63 is fitted in an inner ring of a transmission shaft bearing 23 such as a bearing. When the transmission shaft bearing 23 is a bearing, the transmission shaft bearing 23 is driven (rotated) together with the second transmission shaft 63. The transmission shaft bearing 23 may be a slide bearing that uses, for example, a highly slidable resin.

As shown in FIG. 1, FIG. 2, FIG. 3, FIG. 4, FIG. 5, and FIG. 6, the transducer 11 is housed in the substantially Π shaped (depressed) case member 31 which catches the piezoelectric device 13 from the sides of a bottom surface 13b and a side surface 13c of the piezoelectric device 13. That is, the case member 31 packages (envelopes/houses) the transducer 11 assembled as one unit, as described above.

As shown in FIG. 2, FIG. 5, and FIG. 6, the case member 31 has the positioning grooves 33 for positioning the transducer 11. The positioning groove 33 is Π shaped (depressed) like the holding members 15. The positioning groove 33 is a long groove which is provided along the longitudinal axis direction of the case member 31 and in which the holding member 15 is slidable. The positioning grooves 33 are disposed at two positions corresponding to the holding members 15. The holding members 15 slide in the positioning grooves 33 under the guidance of the positioning grooves 33 and are thus positioned. As a result, the transducer 11 including the piezoelectric device 13 is positioned in the X-axis direction and the Y-axis direction, and the transducer 11 is enveloped in the case member 31 in a positioned state. That is, the case member 31 positions and holds the piezoelectric device 13 (transducer 11) via the holding members 15 and the positioning grooves 33 in the X-axis direction and the Y-axis direction.

As shown in FIG. 5 and FIG. 6, the case member 31 has a Π shaped (depressed) groove 35 at the bottom. The groove 35 is provided with a press member 37 which contacts a bottom surface 13b of the piezoelectric device 13 housed in the case member 31 and which presses the friction contact members 17 (transducer 11) toward the rotor 19 via the piezoelectric device 13. The press member 37 is, for example, a coil spring or a leaf spring.

The case member 31 also has a cut-out 39 on the bottom side. An unshown flexible member for applying a voltage to the piezoelectric device 13 is inserted through the cut-out 39. The flexible member extends outward from the case member 31.

As shown in FIG. 1, FIG. 2, FIG. 3, FIG. 4, FIG. 5, and FIG, 6, the case member 31 is provided with a support mechanism 70. The support mechanism 70 urges, via the first transmission shaft 61, the rotor 19 toward the friction contact members 17 housed in the case member 31, and drivably supports the first transmission shaft 61 so that the rotor 19 is drivable.

The support mechanism 70 has the above-mentioned second transmission shaft 63, the above-mentioned transmission shaft bearing 23, and a bearing support member 53. The second transmission shaft 63 contacts, at its distal end 63a, the proximal end 61b of the first transmission shaft 61, and is driven together with the first transmission shaft 61. The second transmission shaft 63 is fitted in the inner ring of the transmission shaft bearing 23. The bearing support member 53 is provided in an upper surface 31a of the case member 31. The bearing support member 53 supports the transmission shaft bearing 23 so that the second transmission shaft 63 can be driven together with the first transmission shaft 61 and so that the transmission shaft bearing 23 can be driven.

The bearing support member 53 has a substantially planar shape. The bearing support member 53 has an opening 53a which holds the transmission shaft bearing 23 so that the transmission shaft bearing 23 can be driven (rotated) and which fixes the transmission shaft bearing 23 in a fitted state and which supports the transmission shaft bearing 23. The bearing support member 53 is also a rotation force transmission gear support member which supports the rotation force transmission gear 51 via the transmission shaft bearing 23 and the second transmission shaft 63 and the first transmission shaft 61 so that the rotation force transmission gear 51 can be rotated. The bearing support member 53 is also a rotor support member which rotatably supports the rotor 19 via the transmission shaft bearing 23 and the second transmission shaft 63 and the first transmission shaft 61 so that the rotor 19 can be rotated.

The bearing support member 53 has positioning protrusions 53b. The protrusions 53b position the transmission shaft bearing 23 and the second transmission shaft 63 so that the second transmission shaft 63 is aligned with the central axis of the transducer 11 by fitting the protrusions 53b in the positioning grooves 33 when the bearing support member 53 is disposed in the upper surface 31a of the case member 31. Two protrusions 53b are provided to correspond to the positioning grooves 33.

The bearing support member 53 has a thickness and a width that are substantially similar to the thickness and width of the case member 31.

The bearing support member 53 is fastened to an edge 31b of the upper surface 31a of the case member 31 by fastening members 55 such as screws when the protrusions 53b are fitted in the positioning grooves 33. When the bearing support member 53 is fastened to the edge 31b by the fastening members 55 and covers the rotor 19, the above-mentioned press member 37 bends in a desired amount, thereby generating a press force. As a result, the piezoelectric device 13 is pressed along the positioning grooves 33 via the holding members 15, and the friction contact members 17 are pressed against the rotor 19.

Here, the recess 61d and the protrusion 63d are described in detail.

The transducer 11 is positioned in the X-axis direction and the Y-axis direction by the holding members 15 and the positioning grooves 33. Moreover, the second transmission shaft 63 is fitted in the inner ring of the transmission shaft bearing 23, the transmission shaft bearing 23 is supported in the opening 53a by the bearing support member 53, and the bearing support member 53 is fastened to the edge 31b by the fastening members 55, such that the second transmission shaft 63 is positioned in the X-axis direction and the Y-axis direction.

As the recess 61d contacts the protrusion 63d at this moment, the first transmission shaft 61 is positioned in the X-axis direction and the Y-axis direction similarly to the second transmission shaft 63. The rotor 19 is also positioned in the X-axis direction and the Y-axis direction via the first transmission shaft 61.

At the same time, the first transmission shaft 61 is adhesively fixed to the rotation force transmission gear 51 and the rotor 19.

The transducer 11, the case member 31, the bearing support member 53, the transmission shaft bearing 23, and the second transmission shaft 63 are configured in one unit.

As described above, the recess 61d is conical, the protrusion 63d is semispherical, and the protrusion 63d is smaller than the recess 61d. Thus, the first transmission shaft 61 can be tilted around the X-axis and the Y-axis by the recess 61d and the protrusion 63d.

Therefore, as described above, the recess 61d and the protrusion 63d permit the first transmission shaft 61, the rotation force transmission gear 51, and the rotor 19 on the side of the recess 61d to be tilted relative to the second transmission shaft 63, the transducer 11, the case member 31, the bearing support member 53, and the transmission shaft bearing 23 on the side of the protrusion 63d.

The rotor 19 is then pressed against the friction contact members 17 by pressurization when the fastening members 55 fasten the bearing support member 53 to the edge 31b of the upper surface 31a of the case member 31. At this moment, the rotor 19 can be tilted around the X-axis and the Y-axis by the above-mentioned pressurization and by the recess 61d and the protrusion 63d so that the rotor 19 contacts the friction contact members 17 and follows the contact surfaces 17c of the friction contact members 17 when the rotor 19 is positioned in the X-axis direction and the Y-axis direction by the recess 61d and the protrusion 63d.

Now, a method of assembling the ultrasonic motor 10 in the present embodiment is described.

The press member 37 is provided in the groove 35.

The holding members 15 are fixedly attached to the position of the node of the torsional vibration of the piezoelectric device 13 by, for example, an adhesive agent. The friction contact members 17 are fixedly attached to the elliptical vibration generating surface (upper surface 13a) by, for example, an adhesive agent. As a result, the transducer 11 is assembled as one unit. The transducer 11 then slides in the positioning grooves 33 via the holding members 15 and is thus positioned, such that the transducer 11 is positioned in the X-axis direction and the Y-axis direction, and the transducer 11 is packaged (enveloped) by the case member 31 in a positioned state.

At the same time, the press member 37 contacts the bottom surface 13b of the piezoelectric device 13.

The rotor 19 is then mounted on the friction contact members 17, and the rotation force transmission gear 51 is mounted on the rotor 19. The distal end 61a of the first transmission shaft 61 passes through the opening 51a and is disposed in the opening 19a, and the first transmission shaft 61 is adhesively fixed to the rotation force transmission gear 51 and the rotor 19.

The protrusion 63d of the second transmission shaft 63 contacts the recess 61d of the first transmission shaft 61. The second transmission shaft 63 is fitted in the inner ring of the transmission shaft bearing 23.

The transmission shaft bearing 23 is supported by the bearing support member 53 via the opening 53a. The bearing support member 53 is fastened to the edge 31b of the upper surface 31a of the case member 31 by the fastening members 55. At the same time, the press member 37 presses the friction contact members 17 toward the rotor 19 via the piezoelectric device 13.

When the ultrasonic motor 10 is assembled, for example, when the rotor 19 is mounted on the friction contact members 17, the position of the first transmission shaft 61 which is the central (rotation) shaft of the rotor 19 may be displaced relative to the positions of the friction contact members 17 as a result of the processing of the components of the ultrasonic motor 10 and the assembly of the ultrasonic motor 10.

Moreover, after the transducer 11 is assembled, the point of application for pressing (the contact point between the press member 37 and the bottom surface 13b) may be displaced by the assembly of the transducer 11 when the piezoelectric device 13 is pressed by the press member 37 and the friction contact members 17 are pressed toward the rotor 19.

However, in the present embodiment, as the recess 61d contacts the protrusion 63d, the rotor 19 is brought into contact with the friction contact members 17 by pressurization when the fastening members 55 fasten the bearing support member 53 to the edge 31b of the upper surface 31a of the case member 31 when the first transmission shaft 61 and the rotor 19 are positioned in the X-axis direction and the Y-axis direction as described above. Accordingly, the rotor 19 can be tilted around the X-axis and the Y-axis by the recess 61d and the protrusion 63d so that the rotor 19 follows the contact surfaces 17c of the friction contact members 17. Thus, the rotor 19 is pressed against the contact surfaces 17c of the friction contact members 17 by the pressurization of the fastening members 55, and the fastening members 55 fasten the bearing support member 53 to the edge 31b, such that the rotor 19 always uniformly contacts the contact surfaces 17c of the friction contact members 17.

As described above, in the present embodiment, the fastening members 55 are pressurized from the side of the rotor 19 to the side of the transducer 11, such that the rotor 19 is tilted around the X-axis and the Y-axis by the recess 61d and the protrusion 63d, and the rotor 19 always uniformly contacts the contact surfaces 17c.

As the friction contact members 17 are positioned in the X-axis direction and the Y-axis direction by the case member 31 via the piezoelectric device 13, the holding members 15, and the positioning grooves 33, the rotor 19 always uniformly contacts the contact surfaces 17c owing to the first transmission shaft 61 that tilts around the X-axis and the Y-axis.

The displacement of the contact point between the press member 37 and the bottom surface 13b is prevented because the press member 37 is disposed in the groove 35 and because the transducer 11 is positioned in the X-axis direction and the Y-axis direction by the holding members 15 and the positioning grooves 33 as described above.

The protrusions 53b are fitted in the positioning grooves 33, such that the transmission shaft bearing 23 and the second transmission shaft 63 can be quickly positioned, and the second transmission shaft 63 is quickly aligned with the central axis of the transducer 11.

When a voltage is applied to the piezoelectric device 13 via the flexible member, the piezoelectric device 13 induces a longitudinal vibration and a torsional vibration, and from these two vibrations, generates an elliptical vibration. A driving force is transmitted to the rotation force transmission gear 51 from the elliptical vibration generating surface of the piezoelectric device 13 via the friction contact members 17, the rotor 19, and the first transmission shaft 61, and rotates the rotation force transmission gear 51. In this case, as the rotor 19 always uniformly contacts the contact surfaces 17c of the friction contact members 17, stable driving characteristics can be obtained. This rotation force is then transmitted to the unshown device from the side surface of the case member 31 through the rotation force transmission gear 51, and drives the device.

As described above, in the present embodiment, the transducer 11 can be assembled as one unit, and the transducer 11 can be packaged by the case member 31, thereby allowing the transducer 11 and the ultrasonic motor 10 to be simpler in configuration.

Furthermore, in the present embodiment, even if the position of the first transmission shaft 61 which is the central (rotation) shaft of the rotor 19 is displaced relative to the positions of the friction contact members 17 as a result of the processing of the components of the ultrasonic motor 10 and the assembly of the ultrasonic motor 10, the rotor 19 can be positioned in the X-axis direction and the Y-axis direction by the recess 61d and the protrusion 63d, and the positioned rotor 19 can be tilted around the X-axis and the Y-axis by the recess 61d and the protrusion 63d. Thus, in the present embodiment, as the rotor 19 can always uniformly contact the contact surfaces 17c of the friction contact members 17, stable driving characteristics can be obtained.

Still further, in the present embodiment, the press member 37 can be disposed in the groove 35, and the transducer 11 is positioned in the X-axis direction and the Y-axis direction as described above. Thus, after the transducer 11 is assembled, the point of application for pressing (the contact point between the press member 37 and the bottom surface 13b) is not displaced by the assembly of the transducer 11, so that the displacement of the point of application can be prevented.

Still further, in the present embodiment, even if the axial direction of the second transmission shaft 63 is displaced relative to the central axis of the transducer 11, the rotor 19 can be tilted by the recess 61d and the protrusion 63d, and the rotor 19 can always uniformly contact the friction contact members 17, so that stable driving characteristics can be obtained.

Still further, in the present embodiment, as the driving force can be externally transmitted from the side surface of the case member 31 by the rotation force transmission gear 51, the ultrasonic motor 10 can be reduced in thickness. Therefore, in the present embodiment, the ultrasonic motor 10 can be easily disposed in a device that does not have enough space for the diametrical direction of the rotor 19.

Still further, in the present embodiment, the transmission shaft bearing 23 and the second transmission shaft 63 can be quickly positioned by the protrusions 53b, and the second transmission shaft 63 can be quickly aligned with the central axis of the transducer 11.

Still further, in the present embodiment, the protrusion 63d is smaller than the recess 61d, thereby ensuring that the protrusion 63d and the recess 61d can contact each other, enabling the recess 61d to function as a guide, and enabling the second transmission shaft 63 to be easily positioned relative to the first transmission shaft 61.

Although the first transmission shaft 61 has the recess 61d and the second transmission shaft 63 has the protrusion 63d in the present embodiment, the present invention is not limited to this. One of the proximal end 61b of the first transmission shaft 61 (first driving force transmitting member) and the distal end 63a of the second transmission shaft 63 (second driving force transmitting member) may have the recess 61d, and the other may have the protrusion 63d.

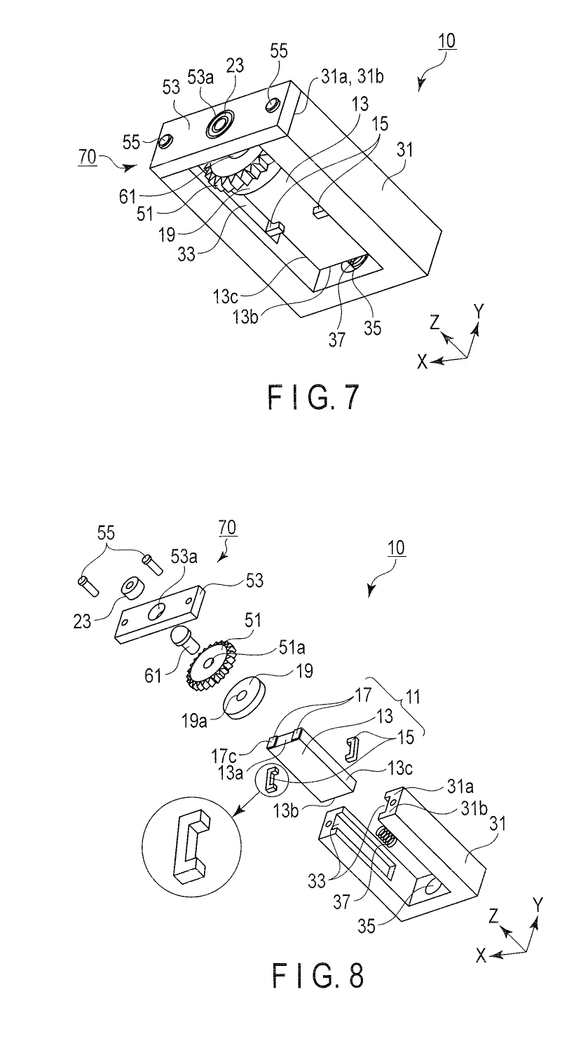

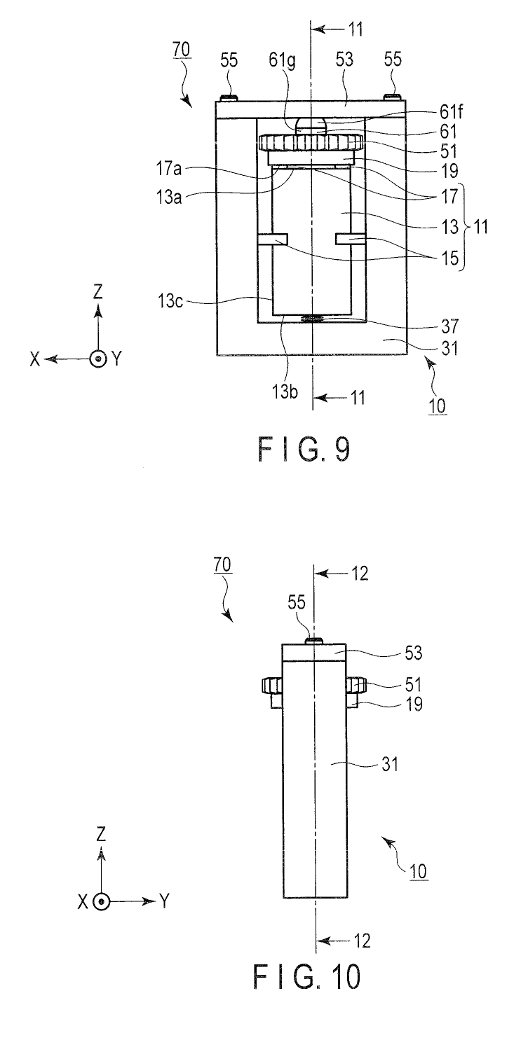

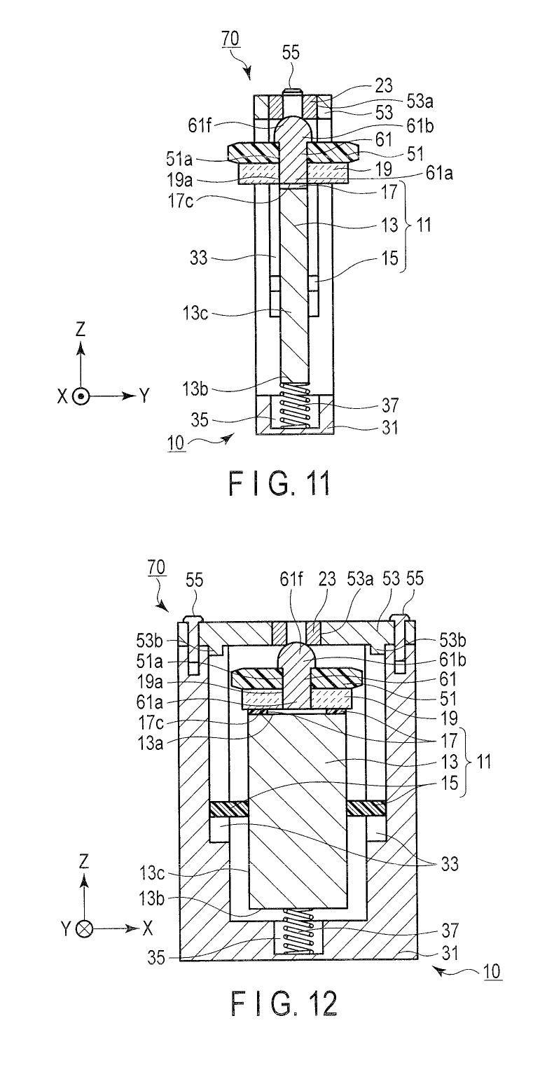

Now, the second embodiment according to the present invention is described with reference to FIG. 7, FIG. 8, FIG. 9, FIG. 10, FIG. 11, and FIG. 12. The same components as those in the first embodiment are provided with the same reference marks as those in the first embodiment and are thus not described.

In the present embodiment, a second transmission shaft 63 may be eliminated. In this case, a first transmission shaft 61 may have a semispherical protrusion 61f at a proximal end 61b, and a transmission shaft bearing 23 may contact the protrusion 61f of the first transmission shaft 61 in its inner ring.

The protrusion 61f of the first transmission shaft 61 is semispherical.

Thus, in the present embodiment, the second transmission shaft 63 can be dispensed with, thereby allowing an ultrasonic motor 10 to be simpler in configuration.

The present invention is not completely limited to the embodiments described above, and the components can be modified at the stage of carrying out the invention without departing from the spirit thereof. Moreover, various inventions can be made by a proper combination of the components disclosed in the embodiments described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ultrasonic motor comprising:
a piezoelectric device, the section of the piezoelectric device perpendicular to its central axis having a length ratio of a rectangle, the piezoelectric device inducing a longitudinal vibration and a torsional vibration in response to a voltage, and generating an elliptical vibration from the longitudinal vibration and the torsional vibration;
a holding member configured to hold the piezoelectric device at the position of a node of the torsional vibration;
a friction contact member configured to be provided in an elliptical vibration generating surface of the piezoelectric device;
a transducer configured to be assembled as one unit by the piezoelectric device, the holding member, and the friction contact member;
a hollow rotor configured to contact the friction contact member, the rotor rotating around a shaft in a direction perpendicular to a plane direction of the elliptical vibration generating surface when a driving force is transmitted to the rotor from the friction contact member;
a first driving force transmitting member configured to be adhesively fixed to the rotor and which rotates together with the rotor;
a case member configured to have a positioning groove to position the transducer and configured to house the transducer;
a press member configured to press the transducer housed in the case member toward the rotor; and
a support mechanism configured to be disposed in the case member and configured to drivably support the first driving force transmitting member so that the rotor is drivable,
wherein the support mechanism includes
a second driving force transmitting member configured to contact a proximal end of the first driving force transmitting member at a distal end of the second driving force transmitting member and configured to be driven together with the first driving force transmitting member,
a transmission shaft bearing having an inner ring in which the second driving force transmitting member is fitted, and
a bearing support member configured to be disposed in the upper surface of the case member, the bearing support member supporting the transmission shaft bearing so that the second driving force transmitting member is drivable together with the first driving force transmitting member and so that the transmission shaft bearing is drivable.

2. The ultrasonic motor according to claim 1, wherein one of the proximal end of the first driving force transmitting member and the distal end of the second driving force transmitting member includes a conical recess, and
the other of the proximal end of the first driving force transmitting member and the distal end of the second driving force transmitting member includes a semispherical protrusion which contacts the recess.

3. The ultrasonic motor according to claim 2, wherein the protrusion is smaller than the recess.

4. The ultrasonic motor according to claim 1, wherein the support mechanism includes
a transmission shaft bearing having an inner ring in which the proximal end of the first driving force transmitting member is fitted, and
a bearing support member configured to be dispose in the upper surface of the case member, the bearing support member drivably supporting the transmission shaft bearing so that the first driving force transmitting member is drivable, and
the proximal end of the first driving force transmitting member is semispherical.
